(19) United States
(12) Patent Application Publication
(10) Pub. No.: US 2026/0145178 A1
(43) Pub. Date: May 28, 2026

(54) BATTERY RECYCLING PLANT AND PROCESS

(71) Applicant: BASF SE, Ludwigshafen am Rhein (DE)

(72) Inventors: Marc DUCHARDT, Ludwigshafen (DE); Wolfram WILK, Ludwigshafen (DE); Fabian SEELER, Ludwigshafen (DE); Kerstin SCHIERLE-ARNDT, Ludwigshafen (DE); Frank MUELLER, Ludwigshafen (DE); Tobias ELWERT, Schwarzheide (DE); Wolfgang ROHDE, Ludwigshafen (DE); Maximilian RANG, Ludwigshafen (DE); Anne-Marie Caroline ZIESCHANG, Ludwigshafen (DE)

(21) Appl. No.: 19/121,591

(22) PCT Filed: Oct. 31, 2023
(86) PCT No.: PCT/EP2023/080413

§ 371 Date: Apr. 16, 2025

(30) Foreign Application Priority Data
Nov. 3, 2022 (EP) 22205373.8

(51) Int. Cl. B03B 9/06; C22B 1/02; C22B 1/248; H01M 10/54

(52) U.S. Cl. CPC B03B 9/06; C22B 1/02; C22B 1/248; H01M 10/54; B03B 2009/066

(57) ABSTRACT

Disclosed herein are a process and a plant for recycling used batteries, the plant including:
a first comminuting device to comminute used batteries to a first degree of comminution to obtain comminuted battery material;
a drying device, arranged downstream of the first comminuting device, to dry the comminuted battery material;
a second comminuting device designed to be explosion-proof and arranged downstream of the drying device, to comminute the dried battery material to a second degree of comminution, the second degree of comminution being greater than the first degree of comminution; and
a pyrolysis device, arranged downstream of the second comminuting device, to pyrolyse the dried and comminuted battery material.

### FIELD OF THE INVENTION

The present disclosure relates to a plant for recycling used batteries, in particular lithium ion batteries, and to a process for recovering valuable materials from used batteries.

### BACKGROUND

Lithium ion battery materials are complex mixtures of various elements and compounds. For example, many lithium ion battery materials contain valuable metals such as lithium, aluminum, copper, nickel, cobalt, and/or manganese. Such active battery material is coated with a binder on a metal foil, such as an aluminium (Al) foil to form a respective battery cathode. It may be desirable to recover various elements and compounds from lithium ion battery materials from waste battery cathodes. For example, it may be advantageous to recover lithium, aluminum, copper, nickel, cobalt, and/or manganese. Accordingly, there is a need for devices and processes for recycling used batteries.

DE 10 2015 207 843 A1 discloses a recycling plant for used batteries. The batteries are pretreated in a complex manner, in particular discharged and dismantled, before they are comminuted and dried. This increases the operating costs of the device, in particular because of the labor required.

EP 2 975 686 B1 refers to a method of recycling cathode material of a lithium ion battery, which comprises: (i) providing a lithium ion battery cathode comprising a metal foil coated with the cathode material; (ii) grinding the cathode in an impact grinder for providing a particulate cathode comprising metal foil particles having an average particle size of at least 200 μm and cathode material particles having an average particle size of less than 200 μm; (iii) filtering the particulate cathode from the impact grinder in a dust collector; (iv) separating the cathode material particles from the particulate cathode for providing recycled cathode material.

CN 111 495 925 A describes a waste lithium battery pyrolyzation, defluorination and dechlorination method which comprises the steps of discharging and dismantling waste lithium batteries; conducting primary crushing, drying a crushed product, conducting primary separation on the dried crushed product, conducting secondary crushing and secondary separation, conducting pyrolyzation, defluorination, dechlorination and in-situ fluorine and chlorine absorption on a separated material, scattering and screening a pyrolyzed product to obtain black powder.

WO 2017/102810 A1 relates to a method for producing a comminuted dry material from a coarse material, the method comprising the steps of: (a) providing a heated drying gas from a drying gas source; (b) providing the coarse material in a storage bin; (c) feeding said coarse material and said heated drying gas into a comminuting equipment; (d) comminuting and drying said coarse material within said comminuting equipment to obtain a comminuted dry material; (e) collecting a mixture of drying gas and comminuted dry material from the comminuting equipment and feeding the mixture to a separator to separate the comminuted dry material from the drying gas; wherein the method further comprises the step of (f) recycling at least part of the drying gas from step (e) as a preconditioning gas and feeding said preconditioning gas into a lower part of said storage bin to precondition the coarse material.

US 2021/359312 A1 relates to a plant for recycling used batteries, comprising a comminuting device to comminute used batteries in a comminuting space, a drying device, arranged downstream of the comminuting device, to dry the comminuted batteries, an intermediate storage device arranged between the comminuting device and the drying device. The plant includes a respective supply line for inert gas for each of the comminuting space of the comminuting device, an intermediate storage space of the intermediate storage device, and a drying space of the drying device.

EP 3 641 036 A1 relates to a plant for recycling used batteries, comprising a comminuting device to comminute used batteries in a comminuting space. The plant includes a drying device, arranged downstream of the comminuting device, to dry the comminuted batteries. The plant includes an intermediate storage device arranged between the comminuting device and the drying device. The plant includes a stirring means to keep the comminuted batteries received in the intermediate storage space in motion. The plant includes a respective supply line for inert gas for each of the comminuting space of the comminuting device, the intermediate storage space of the intermediate storage device, and a drying space of the drying device.

It is an object of the present disclosure to provide an improved recycling plant for used batteries and an improved recycling process for used batteries.

### SUMMARY OF THE INVENTION

A plant for recycling used batteries is provided which provides for a first comminution of the used batteries before and a second comminution of the used batteries after a drying of the used batteries. The plant comprises a first comminuting device to comminute used batteries to a first degree of comminution in a first comminuting space to obtain comminuted battery material. The plant includes a drying device, arranged downstream of the first comminuting device, to dry the comminuted battery material. The plant includes a second comminuting device arranged downstream of the drying device and being configured to further comminute the dried battery material to a second degree of comminution in a second comminuting space, the second degree of comminution being greater than the first degree of comminution. The plant further includes at least one separating device to separate battery material particles of the comminuted battery material of different particle sizes or particle size ranges from each other, i.e. to separate battery material particles of different particle sizes or particle size ranges into two or more fractions of particles of correspondingly two or more different particle size ranges, e.g. to separate battery material particles of a small particle size fraction from battery material particles of a large particle size fraction.

The plant further comprises a pyrolysis device, arranged downstream of the second comminuting device and the at least one separating device and comprising a pyrolysis space.

At least the second comminuting device is designed to be explosion-proof, i.e. explosion-protected, i.e. protected against potentially occurring explosions. In some embodiments, in addition to the second comminuting device, one or more of the other components of the plant, e.g. the first comminuting device, the drying device, one or more of the at least one separating device and/or the pyrolysis device, is also explosion-proof.

A process for recycling used batteries also is provided which comprises comminuting the used batteries to a first degree of comminution using a first comminution device to obtain comminuted battery material, drying the comminuted battery material, comminuting the comminuted and dried battery material to a second degree of comminution using a second comminution device and pyrolyzing the comminuted and dried battery material, e.g. at a temperature in the range of from 400° C. to 600° C.

The present invention is based on the recognition that it is possible by the proposed comminution of the used batteries before and after the drying of the used batteries to efficiently separate active battery material from a metal foil such as an aluminium foil at a yield of at least 95%, e.g. of 99% since the metal foil particles and the active battery material particles of the comminuted battery material have significantly different average particle sizes so that an efficient separation of these particles from each other, e.g. by sieving, becomes possible.

In some embodiments, the first comminuting device already provides for a two-step comminution of the used batteries before drying, using a primary shredder and a downstream secondary shredder. While the primary shredder delivers battery material particles with a size of a diameter of maximum 50 mm, i.e. battery material particles that can pass a sieve size of 50 mm, the secondary shredder delivers battery material particles with a size of a diameter of maximum 20 mm i.e. battery material particles that can pass a sieve size of 20 mm.

In some embodiments, the plant includes an intermediate storage device arranged between the first comminuting device and the drying device. The intermediate storage device further comprises a stirring means which is designed and intended to keep the comminuted battery material received in the intermediate storage space in motion.

In some embodiments the plant includes a plurality of separating devices. In some embodiments, at least one first separating device is arranged between the first comminuting device and the drying device and/or at least one second separating device is arranged between the drying device and the second comminuting device and/or at least one third separating device is arranged between the second comminuting device and the pyrolysis device.

The at least one first separating device is used for pre-sorting the battery material particles of the comminuted battery material, i.e. the battery material is split with the at least one first separating device in order to prevent too large battery material particles of the comminuted batteries from being fed to the drying device.

The at least one second separating device is used for pre-sorting the battery material particles of the comminuted and dried battery material, i.e. the comminuted and dried battery material is split with the at least one second separating device. Thereby, coarse battery material particles of Al and steel (Fe), plastic, foils, etc. are removed and undersize battery material remains. In the scope of the present disclosure, the wording “undersize battery material” is to be understood as battery material of the used batteries that is configured, due to its particle size, to pass a respective separating device.

In some embodiments, the coarser battery material particles of Al and steel (Fe), plastic, foils, etc. are removed using multiple second separating devices, such as sieves, screens, zz sifter which may be connected in series. Undersize battery material may be discharged from each of the series-connected second separating devices and either directly transferred to the pyrolysis device as a first black mass fraction or transferred to the second comminuting device.

At least a part of the undersize battery material is fed to the second comminuting device. In some embodiments the remaining part of the undersize battery material is directly fed to the pyrolysis device.

The at least one third separating device is used for sorting the battery material particles coming from the second comminuting device, i.e. the battery material comminuted by the second comminuting device is split with the at least one third separating device. The undersize battery material which passes the third separating device is fed to the pyrolysis device. In some embodiments, the third separating device is configured to separate battery material particles within a desired size range for direct transfer to the pyrolysis device as second black mass fraction.

In some embodiments, the plant includes a dust collector. In some embodiments, the dust collector is coupled with the second comminuting device and/or at least one of the at least one separating device, comprises a blower, a dust filter and a dust receptable, and is configured to remove/extract dust-laden air from the second comminuting device and/or the respective separating device. Due to the dust collector the safety of the recycling process may be increased. In some embodiments, the dried and comminuted battery material is removed from the second comminuting device and filtered in the dust collector.

The removal of the dried and comminuted battery material is realized by a screen as third separating device arranged downstream the second comminuting device and configured to further separate battery material particles within a desired size range for transfer to the dust collector. Those battery material particles are transferred to the dust collector by using a blower so that no dust can escape to the environmental air. Those battery material particles are collected in the dust filter and may be fed to the pyrolysis device as third black mass fraction. In some embodiments, the battery material particles accumulated in the dust filter may be directly transferred to the pyrolysis device or via a further separating device.

In some embodiments the dust collector is coupled to a second separating device arranged between the drying device and the second comminuting device. The second separating device is configured to let pass only battery material particles within a desired size range for transfer to the dust collector. Those battery material particles are also collected in the dust filter and may be fed to the pyrolysis device as black mass.

In some embodiments, the at least one second separating device and/or the at least one third separating device comprises a plurality of sieves. The sieves of the plurality of sieves may be arranged in series, each sieve being configured to remove particles with a size lying in a sieve-specific size range. The plurality of sieves is configured to be fed by the battery material particles discharged from the drying device and/or the second comminuting device. Depending on the desired degree of splitting, the number of sieving fractions to be provided can be set.

In some embodiments, the plant includes a respective supply line for inert gas for some or each of the first comminuting space of the first comminuting device, the intermediate storage space of the intermediate storage device, a drying space of the drying device, the second comminuting space of the second comminuting device and the pyrolysis space of the pyrolysis device. The supply of inert gas may serve the purpose of explosion protection.

### BRIEF DESCRIPTION OF THE DRAWINGS

FIG. 1 is a schematic representation of an exemplary recycling plant according to the present disclosure.

FIG. 2 is a schematic representation of an exemplary second comminuting device as part of an exemplary recycling plant according to the present disclosure.

### DEFINITIONS

In the present disclosure, the term “battery” not only encompasses non-rechargeable primary cells, but also accumulators, i.e. rechargeable energy storage cells. In particular, the plant of the present disclosure is suitable for processing rechargeable and non-rechargeable storage cells which comprise lithium, in particular lithium compounds and/or lithium ions, and are referred to very generally in the present application as “lithium batteries”.

Furthermore, in the present disclosure, the term “drying” is also used for the removal, in particular evaporation, of the electrolyte, for example dimethyl carbonate (DMC), diethyl carbonate (DEC), and/or ethyl methyl carbonate (EMC). Although it does not only relate to the removal of liquid substances, but can also relate to the removal of solids, the term “drying” has become common in technical language for this purpose.

The term “comminute” is used herein to describe any mechanical treatment of the used batteries in or by any suitable comminuting device, particularly by a shredder and/or a mill, such as a balling mill, preferably a jet mill, an impact mill, particularly a rotor impact mill.

The term “separating device” is used herein for any kind of device suitable to divide battery material particles into different fractions. Thus, a separating device may be, for example, a sieving device, a screening device and/or any combination thereof.

### DETAILED DESCRIPTION

A plant for recycling used batteries is provided which comprises a first comminuting device to comminute used batteries to a first degree in a first comminuting space. The plant includes a drying device, arranged downstream of the first comminuting device, to dry the comminuted batteries to obtain dried battery material. The plant includes a second comminuting device to comminute the dried battery material to a second degree in a second comminuting space, and a pyrolysis device to pyrolyse the comminuted and dried battery material.

In some embodiments, the plant includes an intermediate storage device arranged between the first comminuting device and the drying device. The intermediate storage device further comprises a stirring means which is designed and intended to keep the comminuted battery material received in the intermediate storage space in motion.

In some embodiments some or all components of the plant affected by a possible explosion, such as the first and/or second comminuting device, the drying device, the intermediate device and/or the separating device, are designed to be explosion-proof. According to the invention, at least the second comminuting device is designed to be explosion-proof.

In the following, some measures are proposed which are used or taken individually and/or in combination to achieve the explosion protection according to the invention.

In order to reduce the risk of ignition and/or self-ignition, in some embodiments an inert gas is supplied to at least some of the first comminuting device, the intermediate storage device, the drying device, the second comminuting device and the at least one separating device, thus making the respective devices/components explosion-proof. The inert gas is a gas that at least counteracts, if not even prevents, ignition and/or self-ignition of the comminuted battery material while the electrochemical reactions are taking place. For example, nitrogen gas and/or carbon dioxide gas can be used as the inert gas. The inert gas lowers a concentration of oxygen sufficiently. Thus, an explosion protection can be realized. By inerting with an inert gas a gas cushion is formed inside the potentially explosive area of the respective devices/components of the plant, thus avoiding the formation of an explosive atmosphere.

In some embodiments, explosion-proof means resistant to a pressure of 10 bar over atmospheric pressure, i.e. above ambient pressure, particularly in case of a danger of a dust explosion.

In some embodiments, “designed to be explosion-proof” means that the respective components, e.g. the first comminuting device, the intermediate storage device, the drying device, the second comminuting device and/or the at least one separating device, are structurally (mechanically) designed to withstand a pressure up to 10 bar above ambient pressure, i.e. to be resistant to a pressure up to 10 bar above ambient pressure, e.g. the respective components are reinforced in their respective construction, e.g. have reinforced wall thicknesses.

In terms of a mechanical design of the components of the plant which are affected by a possible explosion, i.e. at least the second comminuting device, some embodiments provide for a reinforcement of the respective components by greater wall thicknesses of the respective components and/or thicker bolts/screws and nuts that prevent walls of the respective components, e.g. walls of the first comminuting device, the intermediate storage device, the drying device, the second comminuting device and/or the at least one separating device, from breaking so that they can withstand greater pressures, e.g. up to 10 bar over atmospheric pressure in case of danger of dust explosion. Thus, the respective components, e.g. the first comminuting device, the intermediate storage device, the drying device, the second comminuting device and/or the at least one separating device, are designed to be shock pressure resistant and thus, explosion-proof. Depending on the respective dimensions of the respective components, their walls and the means, such as bolts, nuts etc., provided for their cohesion, i.e. for their design-related connection to other components are chosen to be appropriately stable in order to withstand a pressure occurring in the event of a possible explosion in a calculable or assessable manner. The constructional (structural) explosion protection described includes reinforcement of the components or structures of the plant that are expected to be potentially exposed to explosion pressure inside the plant and/or to flying parts. As mentioned, this can concern, for example, the first comminuting device, the intermediate storage device, the drying device, the second comminuting device and/or the at least one separating device.

In order to realise the explosion protection for the second comminuting device, i.e. to design the second comminuting device to be explosion-proof, in some embodiments, the second comminuting device is constructed entirely or partly in accordance with the standard DIN EN 13445-3:2021. That means that, to be explosion-proof, the second comminuting device is constructed entirely or partly according to the standard DIN EN 13445-3:2021, i.e. the second comminuting device is explosion-proof by its structural design according to the standard DIN EN 13445-3:2021.

In the context of the present disclosure, in some embodiments, standard DIN EN 13445-3:2021 is also used as a reference to future versions of the standard DIN EN 13445-3:2021, in which case the references to corresponding subchapters within the standard DIN EN 13445-3:2021, which are also mentioned, may need to be adapted.

In some embodiments, the second comminuting device is an impact mill. In some embodiments, the second comminuting device is a rotor impact mill.

Accordingly, in some embodiments, when using an impact mill, e.g. a rotor impact mill, as second comminuting device, a mill casing and/or a grinding chamber of the impact mill are designed to be explosion-proof up to 10 bar over atmospheric pressure. For this, the impact mill, i.e. at least the mill casing and/or the grinding chamber of the impact mill, is constructed in accordance with the standard DIN EN 13445-3:2021. Accordingly, a thickness of the walls of the impact mill, i.e. at least the thickness of the usually flat back wall of the grinding chamber of the impact mill, is approximately proportional to an equivalent diameter of the back wall of the grinding chamber multiplied with the square root of the maximum expected pressure within the impact mill, more precisely approximately proportional to the equivalent diameter of the back wall of the grinding chamber multiplied by the square root of the quotient of the maximum expected pressure within the impact mill, and the existing/permitted tensile stress within the material of construction of the impact mill, i.e. within the material of construction of the grinding chamber. Calculation methods for calculating an equivalent diameter, e.g. the equivalent diameter of the back wall, are well known to the person skilled in the art. The maximum expected pressure for which at least the second comminuting device, e.g. the impact mill as second comminuting device, e.g. the rotor impact mill, is designed to be explosion-proof is 10 bar over atmospheric pressure. The necessary minimum thickness of the back wall of the grinding chamber of the impact mill to be explosion-proof can be determined as follows or is defined as follows (see chapter 10.4.3 of DIN EN 13445-3:2021):

$${d}_{min} = {C}_{1} D \sqrt{\frac{p}{f}}$$

wherein dₘᵢₙ is the minimum thickness of the back wall, C₁ is a proportionality coefficient, D is the equivalent diameter of the back wall, p is the maximum expected pressure within the impact mill, f is the existing/permitted tensile stress within the material of construction of the impact mill, i.e. within the material of construction of the grinding chamber. The permitted tensile stress depends on the material from which the walls are made, i.e. the steel used. For VA steels (i.e. stainless steels), for example, the permitted tensile stress can be in the range of 500 N/mm².

In some embodiments, the walls in question are essentially flat panels. Furthermore, the generally flat panels have a substantially constant thickness, i.e. within a given permissible tolerance range.

In some embodiments, the wall thicknesses for cylindrical walls are also provided in accordance with the standard DIN EN 13445-3:2021 (see, e.g., chapter 7.4 of DIN EN 13445-3:2021).

In some embodiments, wall connections/wall joints which have to be provided due to the design of the plant, e.g. the impact mill, and which may be subject to increased pressure, are chosen as welded and/or screwed connections.

In some embodiments, a screw to be used for this purpose is also designed to be explosion-proof, e.g. a diameter of a screw is chosen to be proportional to the root of a tensile stress that would arise in the screw when a maximum permissible pressure is applied to the plant, e.g. to the impact mill, e.g. to the mill casing or the grinding chamber. The maximum permissible prevailing pressure within the plant, e.g. within the impact mill, is a maximum of 10 bar over atmospheric pressure, as described above. How to lay out a screw to be used for this purpose is further described in Roloff/Matek, Maschinenelemente, Vieweg & Söhne Verlagsgesellschaft, Braunschweig, 7. Auflage, 1976

The above explosion protection measures are described here as an example for the second comminuting device, but can also be taken in an analogous way for the other components of the plant. In some embodiments, in addition to the second comminuting device, also other components of the plant which may be affected by a possible explosion, e.g. the first comminuting device, the intermediate storage device, the drying device, and/or the at least one separating device are designed (constructed) entirely or partly in accordance with standard DIN EN 13445-3:2021. That means that a respective component, e.g. the first comminuting device, the intermediate storage device, the drying device, and/or the at least one separating device, is explosion-proof by its structural design according to the standard DIN EN 13445-3:2021, i.e. due to the fact that it is constructed according to the standard DIN EN 13445-3:2021.

In the case that shock pressure resistant components are coupled to non-shock pressure resistant components via valves, particularly rotary valves/feeder, those valves are also designed to be shock pressure resistant and thus explosion-proof. In some embodiments, the valves are also designed (constructed) entirely or partly in accordance with the standard DIN EN 13445-3:2021. Thereby, a complete plant area comprising components affected by a possible explosion can be designed to be shock pressure resistant and still be connected to the remaining plant components by means of the shock pressure resistant valves. Such complete plant area can be designed for a shock pressure up to 10 bar over atmospheric pressure in case of danger of dust explosion.

In some embodiments, at least the second comminuting device and its inlets and outlets including respective valves arranged at those inlets and outlets are designed to be shock pressure resistant, and, therefore, explosion-proof.

In some embodiments, when using a rotor impact mill as second comminuting device, the circumferential speed or the tip speed of the rotor impact mill is controlled and adjusted in a suitable manner in order to realize an explosion protection. In some embodiments, the circumferential speed or the tip speed of the rotor impact mill is controlled and adjusted within a range of 20-120 meter per second (20 m/s-120 m/s). In some embodiments, the circumferential speed or the tip speed of the rotor impact mill is controlled and adjusted within a range of 30-80 m/s. In some embodiments, the circumferential speed or the tip speed of the rotor impact mill is controlled and adjusted within a range of 40-60 m/s. However, it is to be noted that the power impact depends on the construction size and the circumferential speed of the rotor impact mill and the material fed in and, therefore, can be adjusted accordingly.

In order to realise the explosion protection, in still further embodiments, a shut-off valve, particularly a quick-closing valve is provided on some or every exhaust pipe/exhaust line of the plant. Alternatively or additionally, the length of some or all exhaust lines is selected in such a way that pressure can be relieved along the length of the respective exhaust line. It is to be noted that at least some of the first comminuting device, the drying device, the second comminuting device and the pyrolysis device comprise at least one exhaust line. Pressure measuring means may be provided to detect the pressure prevailing in the plant, particularly in the respective components of the plant affected by a possible explosion and/or the respective exhaust pipes and to control the respective quick-closing valve(s)/flap(s).

In still a further embodiment, a transfer device for transferring the comminuted battery material from the first comminuting device to the intermediate storage device and/or a transfer device for transferring the comminuted battery material from the intermediate storage device to the drying device and/or a transfer device for transferring the dried battery material to the second comminuting device and/or a transfer device for transferring the dried and comminuted battery material from the second comminuting device to the pyrolysis device is designed to be shock pressure resistant and connected to the respective devices adjoining same in a shock pressure resistant manner, e.g. the respective transfer device is structurally designed to withstand a pressure up to 10 bar above ambient pressure, i.e. to be resistant to a pressure up to 10 bar above ambient pressure.

All of these measures, individually or in combination, grant explosion protection and ensure that in the plant according to the disclosure, substantially unprepared batteries, in particular batteries that are not or at least not completely pre-discharged and dismantled, can be recycled in a substantially automated and therefore cost-effective process.

In an exemplary plant, 4 tons of used batteries per hour can be recycled. Used batteries are supplied to the first comminuting device, e.g. in the form of forty batches of 100 kg and e.g. temporarily stored in the intermediate storage device before they are passed on to the drying device. The comminuted battery material may be compacted by a conveying device, for example, a pipe screw conveyor, which transports the material to the drying device. As a conventional drying device, such as a negative-pressure drying device which dries battery material at a pressure of e.g. 50 hPa below ambient pressure and at a temperature of at least 120° C., can only handle 2 tons of battery material per hour, two such drying devices are arranged downstream of the first comminuting device formed by two shredders connected in series, such as, for instance, a primary shredder (pre-shredder) combined with a subsequent secondary shredder, e.g. a universal shredder of the type NGU 0513, as sold by BHS Sonthofen GmbH, Germany. As a rotor impact mill forming the second comminuting device can also usually only handle 2 tons of battery material per hour, two such rotor impact mills are provided downstream of the first comminuting device formed by the two shredders connected in series.

In order to prevent environmentally incompatible or even dangerous gases from escaping from the battery recycling plant, it is proposed in a further embodiment of the plant that the first comminuting space and/or the intermediate storage space and/or the drying space and/or the second comminuting space and/or the at least one separating device are gas-tight.

In a further embodiment, the transfer device for transferring the comminuted battery material from the first comminuting device to the intermediate storage device and/or the transfer device for transferring the comminuted battery material from the intermediate storage device to the drying device and/or the transfer device for transferring the dried battery material to the second comminuting device and/or the transfer device for transferring the dried and comminuted battery material from the second comminuting device to the pyrolysis device is gas-tight and connected to the respective devices adjoining same in a gas-tight manner. Consequently, any transfer device for transferring the processed batteries from and/or to any separating device located between the first comminuting device and the drying device and/or between the drying device and the second comminuting device and/or between the second comminuting device and the pyrolysis device is gas-tight and connected to the respective devices adjoining same in a gas-tight manner.

In a further embodiment, an exhaust gas treatment device is provided which is connected via respective exhaust gas lines to the first comminuting space and/or the intermediate storage space and/or the drying space and/or the second comminuting device and/or any of the at least one separating device located between the drying device and the second comminuting device and/or between the second comminuting device and the pyrolysis device via gas supply lines and is configured to process the gases formed in the first comminuting space and/or in the intermediate storage space and/or in the drying space and/or in the second comminuting space and/or in any of the at least one separating device located between the drying device and the second comminuting device and/or between the second comminuting device and the pyrolysis device. The person skilled in the art is familiar with the components that the exhaust gas treatment device can or should comprise depending on the gas components produced. For this reason, a detailed discussion of the design and function of the exhaust gas treatment device can be dispensed with at this point.

The second comminuting device is arranged downstream of the drying device to further comminute the dried battery material to a second degree of comminution. The second degree of comminution is greater than the first degree of comminution provided by the first comminuting device. While a particle size of maximum 20 mm×20 mm or a particle diameter of maximum 20 mm is achieved in the first comminuting device, a particle size in the range of 0.5-3 mm is achieved in the second comminuting device. It is to be noted that the second comminuting device essentially only treats separator foils and current collector foils as parts of the dried battery material, while all heavy parts of the dried battery material such as housing components have already been separated out by an appropriately positioned second separating device, located between the drying device and the second comminuting device. Furthermore, it is to be noted that active battery material detaching from current collector foils disintegrates as black mass into particles of <250 μm. However, the disintegration of the active battery material is not actually a comminuting, but rather a desagglomeration. Nevertheless, the particles of a size <250 μm are subsumed under battery material produced in and coming out of the second comminuting device. In the second comminuting device, the dried battery material fed in is subjected to mechanical pulping by comminution and subsequently to a pelletisation, so that a second black mass fraction with particles in the size range of <0.25 mm is gained and the foils are present as pelleted particles of a size of 1-5 mm, e.g. 0.5-3 mm.

The pyrolysis device is arranged downstream of the second comminuting device. The pyrolysis device is configured to receive the black mass obtained from the comminuted battery material as first black mass fraction from the first comminuting device, as second black mass fraction from the second comminuting device and/or as third black mass fraction from the dust collector and subject the black mass to a heat treatment in a pyrolysis space provided within the pyrolysis device. In some embodiments, the pyrolysis device includes a supply line for supplying inert gas and/or a reductive gas to the pyrolysis space of the pyrolysis device. In some embodiments of the plant, the pyrolysis device comprises an oven, for instance, an electric oven.

In some embodiments of the plant, a filling device is arranged downstream of the pyrolysis device. The filling device provides the pyrolized battery material for further processing. In some embodiments, the pyrolyzed batteries are filled into transport containers in this filling device.

In some embodiments, the at least one separating device, preferably arranged upstream of the pyrolysis device, is arranged upstream and/or downstream of the second comminuting device. In this separating device, the individual components of the used batteries can be separated from one another and thus supplied to a more targeted processing. At least one of the at least one separating device is preferably a sieve. The sieve may be a vibrating sieve. The respective separating device may comprise one or more sieves. Preferably, the respective separating device comprises more than one sieve.

In some embodiments, at least one first screening device, preferably arranged upstream of the drying device as first separating device, is arranged downstream of the first comminuting device. In this first screening device, only battery material particles of a size of for example maximum 20 mm×20 mm, i.e. battery material particles with a particle diameter of maximum 20 mm are allowed to pass, while larger particles are retained, i.e. the first separating device has a sieve size of maximum 20 mm. Extremely large battery material particles can thus be prevented to enter the drying device. The first separating device may be designed as a sieve unit, for example a perforated sieve, which is arranged as first separating device at the outlet of the first comminuting device. In one embodiment, the openings of the sieve unit have a diameter of about 20 mm. For instance, a primary shredder (pre-shredder) combined with a subsequent secondary shredder, e.g. a universal shredder of the type NGU 0513, as sold by BHS Sonthofen GmbH, Germany, can be used as the first comminuting device.

In some embodiments, at least one second separating device, preferably arranged upstream of the second comminuting device, is arranged downstream of the drying device. In this second separating device, the battery material obtained from the drying device can be separated into fractions having different particle sizes, and the fractions can be supplied to a more targeted downstream processing. Heavy battery material particles such as steel and/or Al can be removed and excluded from any further comminution.

One first fraction of active battery material which could be isolated due to the at least one second separating device may be directly transferred as first black mass fraction to the pyrolysis device. In one embodiment, the first black mass fraction comprises 1-50% w/w C. In one embodiment, this first black mass fraction comprises 20-45% w/w C. In one embodiment, the first black mass fraction comprises 30-40% w/w C. In one embodiment, the first black mass fraction comprises 0.1-10% w/w Al. In one embodiment, the first black mass fraction comprises 1-7% w/w Al. In one embodiment, the first black mass fraction comprises 2-4% w/w Al. In one embodiment, the first black mass fraction comprises 0.5-7% w/w Cu. In one embodiment, the first black mass fraction comprises 1-5% w/w Cu. In one embodiment, the first black mass fraction comprises 1.5-3% w/w Cu. In one embodiment, the first black mass fraction comprises 0-45% w/w Mn. In one embodiment, the first black mass fraction comprises 1.5-30% w/w Mn. In one embodiment, the first black mass fraction comprises 3-10% w/w Mn. In one embodiment, this first black mass fraction comprises 0.01-65% w/w Co. In one embodiment, the first black mass fraction comprises 2-12% w/w Co. In one embodiment, the first black mass fraction comprises 3-5% w/w Co. In one embodiment, the first black mass fraction comprises 0.01-60% w/w Ni. In one embodiment, the first black mass fraction comprises 5-40% w/w Ni. In one embodiment, the first black mass fraction comprises 10-20% w/w Ni. In one embodiment, the first black mass fraction comprises 1-7% w/w Li. In one embodiment, the first black mass fraction comprises 1.5-5.5% w/w Li. In one embodiment, the first black mass fraction comprises 2-4% w/w Li. In one embodiment, the first black mass fraction comprises 1-7% w/W F_{ges}. In one embodiment, the first black mass fraction comprises 1.5-5.5% w/W F_{ges}. In one embodiment, the first black mass fraction comprises 2-4% w/W F_{ges}. In one embodiment, the first black mass fraction comprises 0.1-1.4% w/w P. In one embodiment, the first black mass fraction comprises 0.2-1% w/w P. In one embodiment, the first black mass fraction comprises 0.4-0.6% w/w P. In one embodiment, the first black mass fraction comprises 0-10% w/w Fe. In one embodiment, the first black mass fraction comprises 0.05-1% w/w Fe. In one embodiment, the first black mass fraction comprises 0.1-0.2% w/w Fe. The range specifications of the various elements also apply to the second black mass fraction and the third black mass fraction, respectively. The sum of the fractions of the different elements in one black mass fraction is less than or equal to 100%.

In certain applications a combination of waste battery anode material and waste battery cathode material is used. In other applications, only waste battery cathode material is used. The composition of the black mass also changes accordingly.

In some embodiments, at least one third separating device, preferably arranged upstream of the pyrolysis device, is arranged downstream of the second comminuting device. The at least one third separating device is set up to divide battery material particles of the dried and comminuted battery material coming from the second comminuting device and of different diameters/sizes into a plurality of different fractions of battery material particles according to their respective sizes, i.e. to separate them from each other according to their respective sizes. Each fraction is assigned a specific size range that is different from another fraction. The screen/sieve stages (screen/sieve sizes) are given, for example, by 10 mm, 3 mm, 0.5 mm, 0.25 mm. Further sieves may also be provided in order to further classify the battery material particles. Further metal particles among the battery material particles such as Al and Cu and Fe can be removed and excluded from being processed by the pyrolysis device.

At least one fraction of the plurality of different fractions, preferably the fraction of the smallest particle size <0.25 mm is transferred as second black mass fraction to the pyrolysis device.

A further fraction can be isolated for transfer to the dust collector in which further battery material particles are accumulated as third black mass fraction for transfer to the pyrolysis device.

The present disclosure also provides a process for recycling used batteries. The process uses a plant as described herein and comprises
a) providing used batteries to the first comminuting device,
b) comminuting the used batteries in the first comminuting device to a first degree of comminution to obtain comminuted battery material,
c) transferring the comminuted battery material into the drying device,
d) drying the comminuted battery material,
e) transferring the dried battery material into the second comminuting device,
f) comminuting the dried battery material in the second comminuting device to a second degree of comminution under explosion protection conditions, the second degree of comminution being greater than the first degree of comminution,
g) transferring the dried and comminuted battery material into the pyrolysis device,
h) processing the dried and comminuted battery material in the pyrolysis device, e.g. by heating the dried and comminuted battery material to a temperature of from 400° C. to 630° C., e.g. while contacting the battery material with an inert gas and with a reductive gas generated in situ, to obtain a pyrolized battery material.

At the start of the process, used batteries are provided to a first comminuting device and a second comminuting device before further treated in the pyrolysis device. The first comminuting device may be realized as combination of a primary shredder with a downstream secondary shredder. For instance, a rotor impact mill can be used as the second comminuting device.

At least some, preferably all steps to be carried out between the first comminuting device and the pyrolysis device are executed under inert gas atmosphere. Thereby, an explosion protection can be realized.

Alternatively, or additionally, preferably all steps to be carried out between the first comminuting device and the pyrolysis device are executed in a shock pressure resistant environment. That means that the respective components of the plant which are configured to carry out the respective steps are designed to be shock pressure resistant. Thereby, some embodiments provide for greater wall thicknesses of the respective components and/or thicker bolts and nuts that prevent walls of the respective components from breaking so that they can withstand greater pressures, e.g. up to 10 bar over atmospheric pressure in case of danger of dust explosion. This shock pressure resistant design is also provided for respective connections between the components and transport devices provided on the connections respectively.

In some embodiments of the process, the used batteries are at least one chosen from a lithium ion battery, lithium ion battery waste, lithium ion battery production scrap, lithium ion cell production scrap, lithium ion battery cathode (active) material, lithium ion battery anode (active) material and combinations thereof.

Lithium ion batteries may be disassembled, punched, shredded in the first comminuting device, for example in at least one industrial shredder and/or milled in the second comminuting device, for example in a balling mill, e.g. in a hammer mill, a rotor impact mill, and/or a jet mill. From this kind of mechanical processing, the active battery material of the battery electrodes may be obtained. Different fractions of battery material may be separated from a respective residual active battery material, the respective residual active battery material may be also called “black mass (BM)”. A light fraction such as housing parts made from organic plastics and aluminum foil or copper foil may be removed, using the at least one separating device arranged between the first comminuting device and the pyrolysis device and based, for example, on forced stream of gas, air separation, classification or sieving. As outlined before, there may be a plurality of separating devices, for example, at least one first separating device between the first comminuting device and the drying device and/or at least one second separating device between the drying device and the second comminuting device and/or at least one third separating device between the second comminuting device and the pyrolysis device.

In the scope of the present disclosure the wording “used batteries” comprises battery scraps that may stem from, e.g., spent batteries or from production waste such as off-spec material. In some embodiments, black mass is obtained from mechanically treated battery scraps, for example from battery scraps treated in a hammer mill, a rotor mill or in an industrial shredder. Such black mass may have an average particle diameter (D₅₀) ranging from 1 μm to 1 cm, such as from 1 μm to 500 μm, and further for example, from 3 μm to 250 μm.

Larger parts of the used batteries like the housings, the wiring and the electrode carrier films may be separated mechanically such that the corresponding materials may be excluded from the used batteries employed in the process of the present disclosure. In some embodiments, the separation is done by manual or automated sorting. For example, magnetic parts can be separated by magnetic separation, non-magnetic metals can be separated by eddy-current separators. Other techniques may comprise air jigs and air tables.

The batteries comminuted to a first degree of comminution are transferred into the drying device and dried. In some embodiments of the process, the dried battery material comprises an aluminum foil and an active battery material.

In some embodiments, the dried battery material comprises nickel, cobalt, manganese, copper, aluminum, iron, phosphorus, or combinations thereof and an active battery material.

The dried battery material is further comminuted in the second comminuting device.

Using at least one separating device, arranged between the first communiting device and the pyrolysis device, the comminuted battery material may be separated into different fractions, wherein at least a part of those fractions are removed and excluded from the further process. For the sake of simplicity, the battery material that passes through the respective further process is always referred to as battery material, despite the different composition in each process step. The battery material which is finally fed to the pyrolyse device is herein also referred to as black mass or black mass fraction.

The comminuted and dried battery material that is transferred into a pyrolysis device is subsequently heated, e.g. to a temperature of from 400° C. to 630° C., e.g. while contacting the comminuted and dried batteries with an inert gas and with a reductive gas generated in situ by thermal decomposition of the comminuted and dried battery material, to obtain a pyrolized battery material.

In some embodiments, the flow rate of the inert gas is in the range of from 50 to 250 Sm³/h, such as from 75 to 200 Sm³/h, e.g. from 100 to 150 Sm³/h, for instance, 120 Sm³/h (standard cubic metre per hour).

In some embodiments, the inert gas comprises at least one gas chosen from argon (Ar), dinitrogen (N₂), helium (He), and mixtures thereof.

In some embodiments of the process, the comminuted and dried battery material is fed to the pyrolysis device that may be a rotary kiln, using at least one screw conveyor.

As provided herein, different process parameters may produce as intermediate materials black mass fractions having different compositions and/or properties. Intermediate materials having, for example, a favorable composition, mechanical properties, surface hydrophilicity, and/or porosity may, e.g., result in improved processibility and/or recovery in subsequent downstream processing steps.

The present disclosure also provides a use of the pyrolized battery material of the present disclosure in the recovery of valuable materials from used batteries. In some embodiments, the pyrolized battery material is used as an intermediate for a downstream leaching process.

For example, a pyrolyzed black mass fraction comprising the pyrolized battery material can be leached with an acidic aqueous solution comprising, e.g., sulfuric acid (H₂SO₄) to obtain a solution comprising one or more value metal ions. The solution comprising one or more value metal ions may be further purified via, e.g., solvent exchange, ion-exchange, precipitation, extraction, and/or electrolysis.

Without wishing to be bound by theory, it is believed that the pyrolized battery material has beneficial properties for improving one or more downstream processes such as leaching. For instance, it is believed that the embrittlement of the composite material may, e.g., result in smaller particles that have a more beneficial surface-to-volume ratio facilitating dissolution during acid leaching. The smaller particle size may additionally facilitate subsequent transport steps, such as conveying.

### EXAMPLE

The present disclosure will be explained in more detail below on the basis of an embodiment with reference to the accompanying drawings.

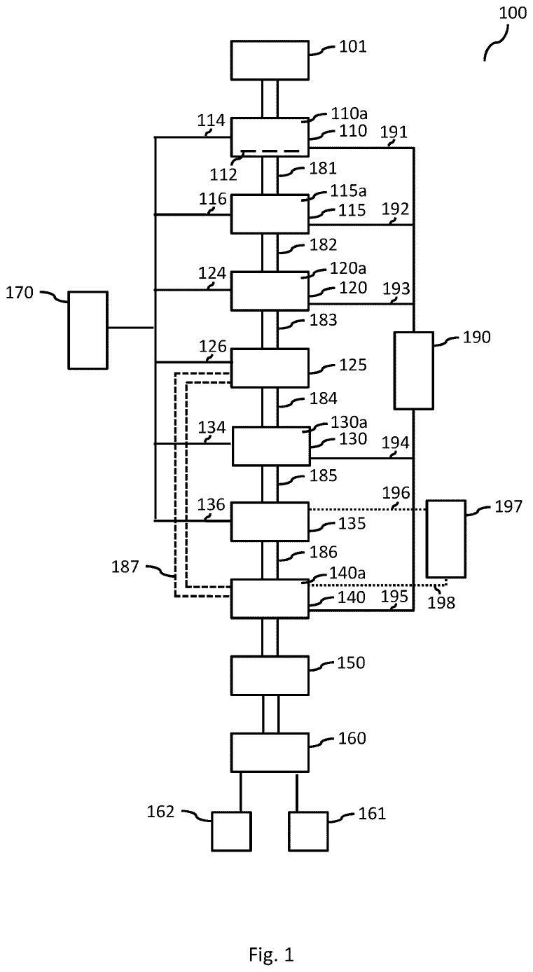

FIG. 1 is a schematic sketch of an embodiment of the plant for recycling used batteries of the present disclosure. The plant for recycling used batteries is denoted by the reference sign 100. The plant 100 comprises a first comminuting device 110, an intermediate storage device 115, a drying device 120, a second comminuting device 130, a first separating device 112, a second separating device 125, a third separating device 135 and a pyrolysis device 140.

The plant 100 is designed for batch-wise operation. In other words, a predetermined amount of used batteries, for example 100 kg of used lithium batteries, is supplied to the first comminuting device 110 by an upstream dosing device 101, which is used to divide the delivered used batteries into individual portions of the predetermined amount.

The first comminuting device 110 can be equipped with a sieve device 112 as the first separating device on the outlet side, for example, a perforated plate with holes having a diameter of approximately 20 mm. In order to prevent environmentally incompatible gases from escaping from the first comminuting device 110, said device is preferably gas-tight. In addition, the first comminuting device 110 can be equipped with a supply line 114 for inert gas, via which inert gas can be supplied from an inert gas supply unit 170 to the first comminuting space 110a of the first comminuting device 110, which reduces, if not completely excludes, the risk of ignition and/or self-ignition of the comminuted battery material.

After a predetermined residence time in the first comminuting device 110, the batteries comminuted to a first degree of comminution are conveyed to the intermediate storage device 115. This intermediate storage device 115 is also preferably gas-tight. In addition, inert gas can also be supplied from the inert gas supply unit 170 to the intermediate storage device 115 via a feed line 116 in order to be able to reduce, if not completely exclude, the risk of ignition and/or self-ignition of the comminuted battery material. The intermediate storage device 115 also has stirring means which constantly mix the battery material received and comminuted in the intermediate storage space 115a in order to prevent the formation of partial volumes of excessive temperature. In the event that the temperature in the intermediate storage space 115a rises too much, the intermediate storage device 115 also has a cooling device, for example cooling coils through which cooling medium flows, which are attached to the outer boundary wall of the intermediate storage space 115a and are in heat-exchange contact therewith.

After the battery material from a predetermined number of comminution processes has been received in the intermediate storage device 115, the intermediate storage space 115a is emptied in the direction of the drying device 120, the drying space 120a of which is preferably also gas-tight and may also comprise stirring means. Furthermore, inert gas can also be supplied to the drying space 120a via a line 124.

In the embodiment shown, the drying device 120 is a negative-pressure drying device which dries the comminuted battery material at a pressure of 50 hPa below ambient pressure and at a temperature of at least 120° C. There are a pressure control unit and a temperature control unit required for this purpose which are not explicitly denoted in FIG. 1 by reference signs.

After the comminuted battery material has been dried in the drying device 120, the drying space 120a is emptied in the direction of the second comminuting device 130.

At least one separating device can be arranged downstream of the drying device 120, i.e. upstream and/or downstream of the second comminuting device 130, in which screening device the individual components of the comminuted and dried battery material can be separated from one another and thus supplied to a more targeted processing. In principle, it is possible to arrange a plurality of screening stages one behind the other, upstream and/or downstream of the second comminuting device 130. In some embodiments, one of the screening stages comprises a simple sieve.

In some embodiments, the second separating device 125 may be located between the drying device 120 and the second communiting device 130, in order to pre-sort the dried battery material before feeding it to the second comminuting device 130 and a heavy fraction such as steel and Al particles can be removed, i.e. sorted-out and purged/discharged. It is possible that a fraction of active battery material (first black mass fraction) is directly transferred via transfer device 187 as indicated by dashed-line to the pyrolysis device 140 without being further comminuted by the second comminuting device 130.

In some embodiments, the second comminuting device 130 is equipped with a third separating device 135 on its outlet side and/or a third separating device 135 can be located downstream of the second comminuting device 130 in the direction of the pyrolysis device 140 so that further particles, such as Fe, Cu, and Al particles and plastic particles (e.g. PP, PE) can be sorted-out and purged/discharged. The plastic particles may comprise separator pieces of different sizes and splinters from housing parts which can be made of different plastic partly also with an organic filler material. The remaining undersize battery material is transferred as second black mass fraction to the pyrolysis device 140.

In order to prevent environmentally incompatible gases from escaping from the second comminuting device 130, said device 130 is preferably also gas-tight.

In addition, the second comminuting device 130 is designed to be explosion-proof. Therefore, the second comminuting device 130 can also be equipped with a supply line 134 for inert gas, via which inert gas can be supplied to the second comminuting space 130a of the second comminuting device 130, which reduces, if not completely excludes, the risk of ignition and/or self-ignition of the comminuted battery material. The separating devices 125, 135 may also be gas-tight and/or equipped with a respective supply line 126, 136 for inert gas.

Alternatively or additionally, the second comminuting device 130 is designed to be shock pressure resistant. Thereby, the second comminuting device 130 is provided with greater wall thicknesses and/or thicker bolts and nuts that prevent walls of the second comminuting device 130 from breaking so that they can withstand greater pressures, e.g. up to 10 bar over atmospheric pressure in case of danger of dust explosion.

The battery material comminuted to a second degree in the second comminuting space 130a of the second comminuting device 130 and preferably sorted and released from out-sorted fractions are transferred as second black mass fraction to the pyrolysis device 140. The first black mass fraction from the second separating device 125 and the second black mass fraction from the third separating device 135 may be combined before being fed to the pyrolysis device 140 or fed as separate fractions to the pyrolysis device 140.

The pyrolysis device 140 receives the comminuted and dried and optionally screened battery material as black mass in a pyrolysis space 140a, where the black mass is subjected to a heat treatment under reducing conditions to obtain a pyrolized battery material.

A further screening device 150 can be arranged downstream of the pyrolysis device 140, in which screening device 150 different fractions of the pyrolyzed battery material can be separated from one another and thus supplied to a more targeted processing. In principle, it is possible to arrange a plurality of screening stages one behind the other. In some embodiments, one of the screening stages comprises a simple sieve.

Finally, the pyrolized battery material can be filled into transport containers 161, 162 in a filling device 160.

It should also be noted that in some embodiments not only the first comminuting device 110, the intermediate storage device 115, the drying device 120, the second comminuting device 130 and the pyrolysis device 140 can be made gas-tight, but also the separating devices 112, 125, 135 and the transfer devices 181, 182, 183, 184, 185 and 186 and 187, which transfer the comminuted battery material between the respective devices of the plant, e.g. from the first comminuting device 110 to the intermediate storage device 115 (transfer device 181), from the intermediate storage device 115 to the drying device 120 (transfer device 182), from the drying device 120 to the second separating device 125 (transfer device 183), from the second separating device 125 to the second comminuting device 130 (transfer device 184), from the second comminuting device 130 to the third separating device 135 (transfer device 185), from the third separating device 135 to the pyrolysis device 140 (transfer device 186) and/or from the second separating device 125 directly to the pyrolysis device 140 (transfer device 187), respectively.

It should also be noted that potentially environmentally hazardous gases formed in the first comminuting device 110, the intermediate storage device 115, the drying device 120, the second comminuting device 130 and the pyrolysis device 140 can be supplied via lines 191, 192, 193, 194, 195 to an exhaust gas treatment device 190 of a known type, in which they are processed in an environmentally friendly manner.

Furthermore, it should also be noted that at least one of the first comminuting device 110, the intermediate storage device 115, the drying device 120, and the second comminuting device 130 is made shock pressure resistant, and also the separating devices 112, 125, 135 and the transfer devices 181, 182, 183, 184, 185 and 186 and 187, which transfer the comminuted battery material between the respective devices of the plant, e.g. from the first comminuting device 110 to the intermediate storage device 115 (transfer device 181), from the intermediate storage device 115 to the drying device 120 (transfer device 182), from the drying device 120 to the second separating device 125 (transfer device 183), from the second separating device 125 to the second comminuting device 130 (transfer device 184), from the second comminuting device 130 to the third separating device 135 (transfer device 185), from the third separating device 135 to the pyrolysis device 140 (transfer device 186) and/or from the second separating device 125 directly to the pyrolysis device 140 (transfer device 187), respectively, can be made shock pressure resistant.

The third separating device 135 is connected with a dust collector 197 via a gas line 196. The pyrolysis space 140a is also connected with the dust collector 197 via a gas line 198.

Finally, it should also be noted that all of the above-mentioned devices of the battery recycling plant 100 can have associated inlet and/or outlet double gate locks (not shown in FIG. 1).

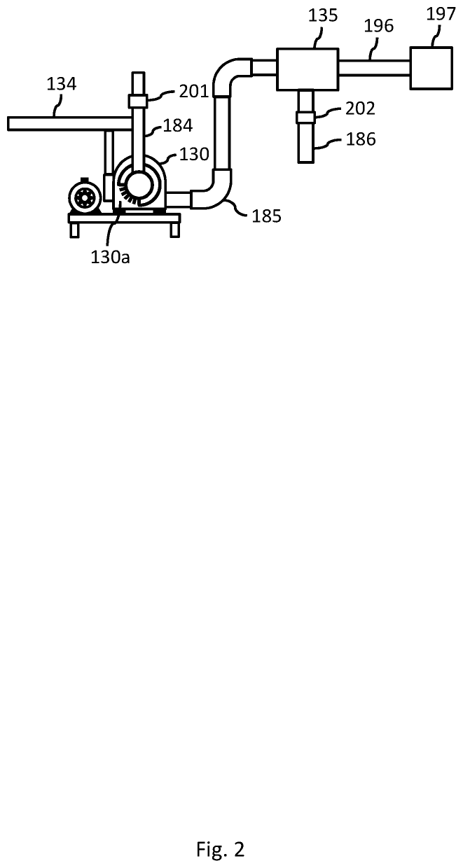

FIG. 2 shows, in a schematic representation, an exemplary second comminuting device 130 as part of an exemplary recycling plant according to the present disclosure. Accordingly, a transfer device 184 equipped with a rotary feeder 201 is provided for feeding dried battery material from the drying device 120 (not shown here) into the second comminuting space 130a of the second comminuting device 130, the second comminuting device 130 being here a rotor impact mill. The outlet of the rotor impact mill 130 is in fluid flow connection through transport device 185 with the third separating device 135. The third separating device 135 is in fluid flow connection through transport device 186 with the pyrolysis device 140. A rotary feeder 202 is used to feed via transport device 186 the battery material particles accumulated in the third separating device 135 as second black mass fraction to the pyrolysis device 140 (not shown here). In the embodiment shown here, the third separating device 135 is coupled with the dust collector 197 through the gas line 196. The third separating device 135 is exemplarily designed as a screen and arranged downstream the second comminuting device 130 and configured to separate battery material particles within a desired size range for transfer to the dust collector 197. Those battery material particles are transferred via transport line 196 to the dust collector 197 by using a blower so that no dust can escape to the environmental air. Those battery material particles are collected in the dust filter 197 and may also be fed via transport line 198 (not shown here) to the pyrolysis device 140 as third black mass fraction.

### LIST OF REFERENCE SIGNS

100 plant
101 dosing device
110 first comminuting device
110a first comminuting space
112 first separating device
114 supply line for inert gas
115 intermediate storage device
115a intermediate storage space
116 supply line for inert gas
120 drying device
120a drying space
124 supply line for inert gas
125 second separating device
126 supply line for inert gas
130 second comminuting device
130a second comminuting space
134 supply line for inert gas
135 third separating device
140 pyrolysis device
140a pyrolysis space
150 screening device
160 filling device
161 transport container
162 transport container
170 inert gas supply unit
181 transfer device
182 transfer device
183 transfer device
184 transfer device
185 transfer device
186 transfer device
187 transfer device
190 exhaust gas treatment device
191 line to exhaust treatment device
192 line to exhaust treatment device
193 line to exhaust treatment device
194 line to exhaust treatment device
195 line to exhaust treatment device
196 transport line
197 dust collector
198 transport line
201 rotary feeder
202 rotary feeder

1. A plant for recycling used batteries, comprising:
a first comminuting device to comminute used batteries to a first degree of comminution in a first comminuting space to obtain comminuted battery material;
a drying device, arranged downstream of the first comminuting device, to dry the comminuted battery material;
a second comminuting device arranged downstream of the drying device, to comminute the dried battery material to a second degree of comminution in a second comminuting space, the second degree of comminution being greater than the first degree of comminution; and
a pyrolysis device, arranged downstream of the second comminuting device, to pyrolyse the dried and comminuted battery material in a pyrolysis space,
wherein at least the second comminuting device is designed to be explosion-proof.

2. The plant according to claim 1, wherein, to be explosion-proof, at least the second comminuting device is mechanically designed to be resistant to a pressure up to 10 bar above ambient pressure.

3. The plant according to claim 2, wherein, to be explosion-proof, at least the second comminuting device is constructed entirely or partly in accordance with the standard DIN EN 13445-3:2021.

4. The plant according to claim 1, wherein the second comminuting device is an impact mill.

5. The plant according to claim 4, wherein the second comminuting device is a rotor impact mill wherein, to be explosion-proof, a circumferential speed or a tip speed of the rotor impact mill is controlled and adjusted within a range of 20-120 meter per second.

6. The plant according to claim 4, wherein, to be explosion-proof, a minimum thickness of a back wall of a grinding chamber of the impact mill is given by:
$${d}_{min} = {C}_{1} D \sqrt{\frac{p}{f}}$$
wherein dₘᵢₙ is the minimum thickness of the back wall, C₁ is a proportionality coefficient, D is an equivalent diameter of the back wall, p is a maximum expected pressure within the grinding chamber, and f is an existing/permitted tensile stress in the material of construction of the rotor impact mill.

7. The plant according to claim 1, wherein at least the second comminuting device is equipped with at least one supply line for supplying inert gas to the second comminuting space of the second comminuting device.

8. The plant according to claim 1, wherein at least the second comminuting space is gas-tight.

9. The plant according to claim 1, wherein one or more of a transfer device for transferring the dried and comminuted battery material from the second comminuting device to the pyrolysis device or a transfer device for transferring the dried battery material from the drying device to the second comminuting device is gas-tight and connected to adjoining devices in a gas-tight manner, wherein each of the inlets and outlets of the second comminuting device and/or each of the transfer devices adjoining the second comminuting device is mechanically designed to be resistant to a pressure up to 10 bar above ambient pressure.

10. The plant according to claim 1, further comprising an exhaust gas treatment device connected to one or more of the first comminuting space, a drying space of the drying device, or the second comminuting space of the second comminuting device via respective gas supply lines and configured to process the gases formed in one or more of the first comminuting space, the second comminuting space, or in the drying space.

11. The plant according to claim 1, further comprising at least one shut-off valve the at least one shut-off valve being controlled by pressure measuring means.

12. The plant according to claim 1, further comprising at least one separating device upstream of the pyrolysis device, comprising as a first separating device a sieve unit arranged at an outlet of the first comminuting device, comprising as a second separating device at least one screening device arranged upstream of the second comminuting device and downstream of the drying device and/or comprising as a third separating device at least one screening device arranged downstream of the second comminuting device.

13. The plant according to claim 1, further comprising a dust collector which is coupled at least with the second comminuting device and/or with at least one separating device, and comprises a blower, a dust filter and a dust receptable, and is configured to remove/extract dust-laden air from the second comminuting device and/or the respective separating device.

14. The plant according to claim 1, further comprising a filling device arranged downstream of the pyrolysis device.

15. A process for recycling used batteries by using a plant according to claim 1, wherein the process comprises at least:
a) providing used batteries to the first comminuting device,
b) comminuting the used batteries in the first comminuting device to a first degree of comminution to obtain comminuted battery material,
c) transferring the comminuted battery material into the drying device,
d) drying the comminuted battery material,
e) transferring the dried battery material into the second comminuting device,
f) comminuting the dried battery material in the second comminuting device to a second degree of comminution, the second degree of comminution being greater than the first degree of comminution,
g) transferring the comminuted and dried battery material into the pyrolysis device, and
h) processing the comminuted and dried battery material in the pyrolysis device.

16. The plant according to claim 4, wherein the second comminuting device is a rotor impact mill wherein, to be explosion-proof, a circumferential speed or a tip speed of the rotor impact mill is controlled and adjusted within a range of 30-80 m/s.

17. The plant according to claim 4, wherein the second comminuting device is a rotor impact mill wherein, to be explosion-proof, a circumferential speed or a tip speed of the rotor impact mill is controlled and adjusted within a range of 40-60 m/s.

18. The plant according to claim 1, wherein one or more of a transfer device for transferring the dried and comminuted battery material from the second comminuting device to the pyrolysis device or a transfer device for transferring the dried battery material from the drying device to the second comminuting device is a rotary feeder that is configured to feed the dried battery material to the second comminuting device and/or to transfer the comminuted battery material from the second comminuting device in the direction of the pyrolysis device and/or a valve configured to supply any transport gas to the second comminuting device and/or to discharge exhaust gas from the second comminuting device.

19. The plant according to claim 11, wherein at least one shut-off valve is a quick-closing valve.
